(19) United States
(12) Patent Application Publication
(10) Pub. No.: US 2026/0135417 A1
(43) Pub. Date: May 14, 2026

(54) MOTOR AND MANUFACTURING METHOD THEREOF

(71) Applicant: MITSUBA Corporation, Gunma (JP)

(72) Inventors: TAKAHIRO NAGAI, Gunma (JP); YUTA SUZUKI, Gunma (JP); KAZUAKI KOBAYASHI, Gunma (JP); DAI YAMAMOTO, Gunma (JP); KEITA NAKABAYASHI, Gunma (JP)

(73) Assignee: MITSUBA Corporation, Gunma (JP)

(21) Appl. No.: 18/713,693

(22) PCT Filed: Sep. 14, 2023
(86) PCT No.: PCT/JP2023/033526

§ 371 Date: May 27, 2024

(30) Foreign Application Priority Data
Dec. 16, 2022 (JP) 2022-201168

(51) Int. Cl. H02K 1/12; H02K 1/22; H02K 5/04; H02K 15/062

(52) U.S. Cl. CPC H02K 1/12; H02K 1/22; H02K 5/04; H02K 15/062

(57) ABSTRACT

The present invention provides a motor and a manufacturing method thereof that can firmly fix an insulator and appropriately suppress vibration during driving. A motor 1 includes: a cylindrical stator 3 that has a cylindrical insulator 11 with insulating properties in which a plurality of winding portions 11d are arranged in the circumferential direction, and a plurality of winding coils 12 provided on each winding portion 11d of the insulator 11; a rotor 2 that is rotatably disposed inside the stator 3; and an annular bus bar unit 7 that supplies power to the plurality of winding coils 12. The bus bar unit 7 is fixed to one end side of the insulator 11.

### TECHNICAL FIELD

The present invention relates to a motor, such as a so-called brushless motor, and a manufacturing method thereof.

### RELATED ART

In recent years, efforts to promote the Sustainable Development Goals (2030 Agenda for Sustainable Development, adopted by the United Nations Summit on Sep. 25, 2015, hereinafter referred to as “SDGs”) have been made on an international scale. Specifically, the SDGs include “Goal 9: Industry, Innovation and Infrastructure” and “Goal 12: Responsible Consumption and Production,” and there is a desire for technological development aimed at achieving these goals.

The technology described in Patent Document 1 is known as a technology that can contribute to achieving these goals. Patent Document 1 describes a motor in which “the bus bar holder 232A that holds the bus bar 231A has an annular holder main body portion 60A, and a first leg portion 61A and a second leg portion 62A extending downward from the holder main body portion 60A. The first leg portion 61A has a claw portion 611A that protrudes laterally. The upper surface of the claw portion 611A and the lower surface of a receiving portion 521A provided on the insulator 52A face each other in the axial direction with a gap therebetween. Therefore, upward movement of the bus bar holder 232A is restricted by the claw portion 611A and the receiving portion 521A of the insulator 52A. On the other hand, the lower end portion of the second leg portion 62A abuts against the tooth 512A or the insulator 52A.”

### CITATION LIST

### Patent Document

[Patent Document 1] Japanese Patent Application Laid-Open No. 2013-42633

### SUMMARY OF INVENTION

### Technical Problem

In the motor described in Patent Document 1, although the claw portion 611A protruding laterally from the first leg portion 61A of the bus bar holder 232A engages with the receiving portion 521A of the insulator 52A to restrict the upward movement of the bus bar holder 232A, there are only three first leg portions 61 formed around the circumferential direction of the bus bar holder 232A, and the first leg portions 61 are provided at positions outside the inner peripheral surfaces of the teeth 512A. Therefore, the insulator cannot be firmly fixed, which poses the problem that the vibration that may occur when the motor is driven cannot be appropriately suppressed.

The present invention has been made to solve the above-mentioned problem, and an object of the present invention is to provide a motor and a manufacturing method thereof that can firmly fix the insulator and appropriately suppress vibration during driving.

### Solution to Problem

The present invention provides a motor, including: a cylindrical stator that has a cylindrical insulator with insulating properties in which a plurality of winding portions are arranged in a circumferential direction, and a plurality of winding coils provided on each winding portion of the insulator; a rotor that is rotatably disposed inside the stator; and an annular bus bar unit that supplies power to the plurality of winding coils, in which the bus bar unit is fixed to one end side of the insulator.

### Effects of Invention

According to the present invention, it is possible to firmly fix the insulator and appropriately suppress vibration during driving.

### BRIEF DESCRIPTION OF DRAWINGS

FIG. 1 is a side view showing a motor according to an embodiment of the present invention.

FIG. 2 is a cross-sectional view of the motor with a portion cut away in the axial direction.

FIG. 3 is a partial perspective view of the motor.

FIG. 4 is a partial radial cross-sectional view of the motor.

FIG. 5 is a partial axial cross-sectional view of the motor.

FIG. 6 is a side view of the motor with a portion cut away.

FIG. 7 is a perspective view showing an insulator of the motor.

FIG. 8 is a perspective view showing a thermistor of the motor.

(A) and (B) of FIG. 9 are views showing a leaf spring material of the motor, wherein (A) is a perspective view from the outside and (B) is a perspective view from the inside.

FIG. 10 is a perspective view showing a bus bar unit of the motor from the rear side.

FIG. 11 is a perspective view showing the bus bar unit from the front side.

FIG. 12 is a schematic view showing a state where the motor is attached to a side-mounted electric motorcycle.

FIG. 13 is a schematic view showing a state where the motor is attached to a center-mounted electric motorcycle.

FIG. 14 is a process diagram showing manufacturing steps of the motor.

### DESCRIPTION OF EMBODIMENTS

### One Embodiment

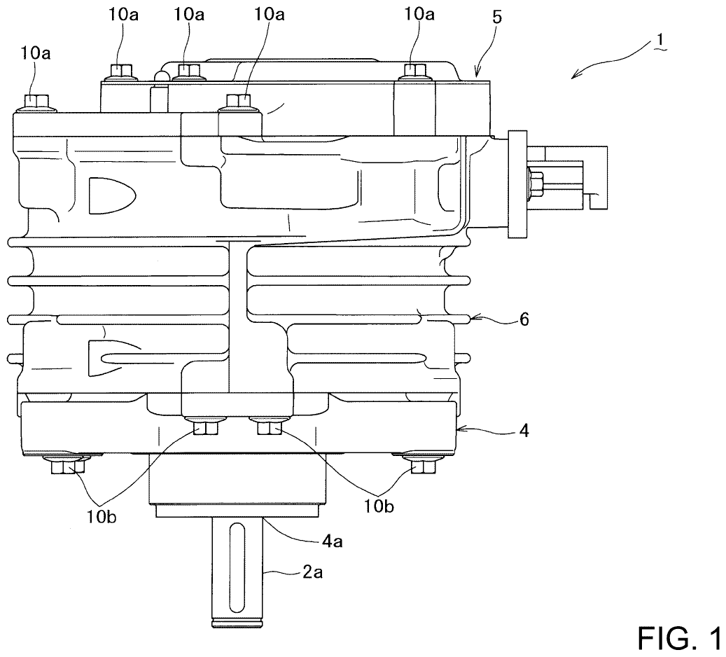

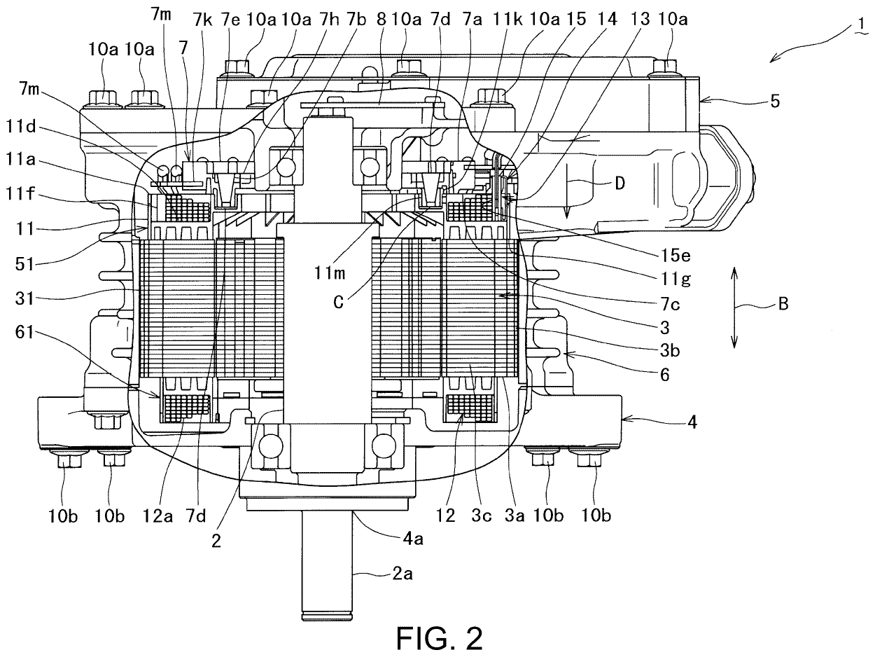

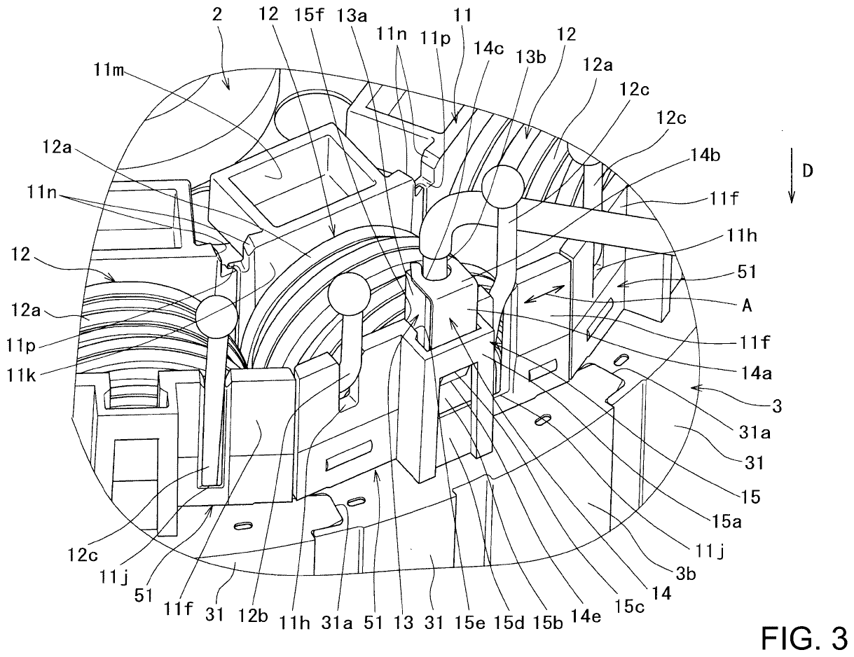

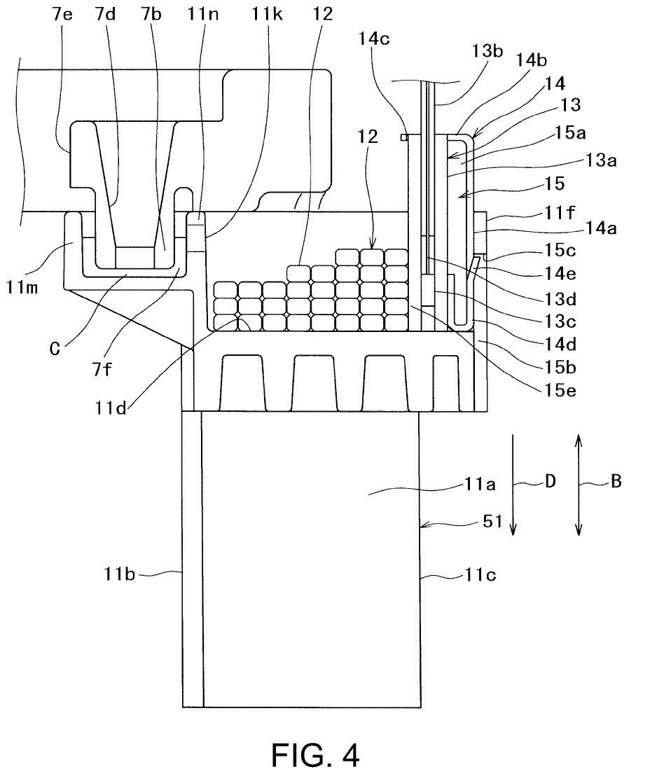

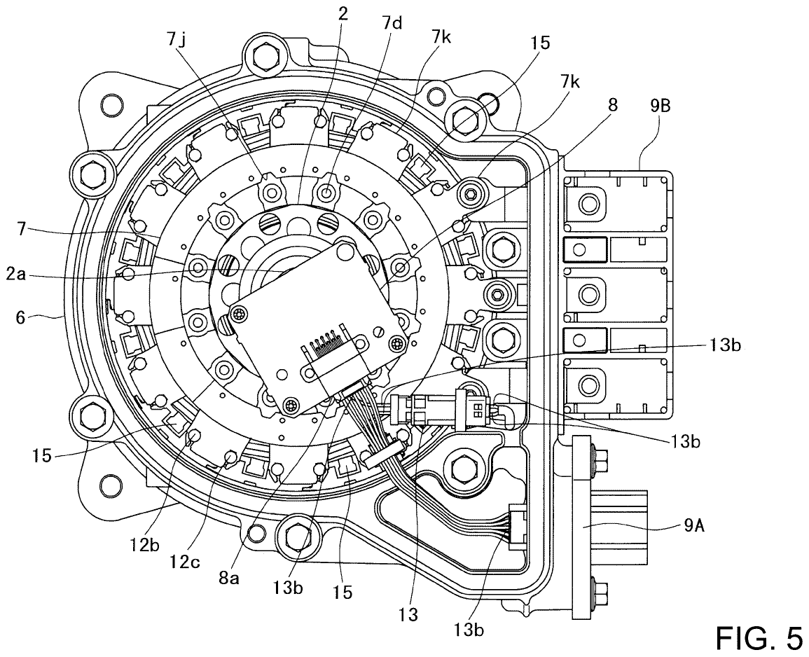

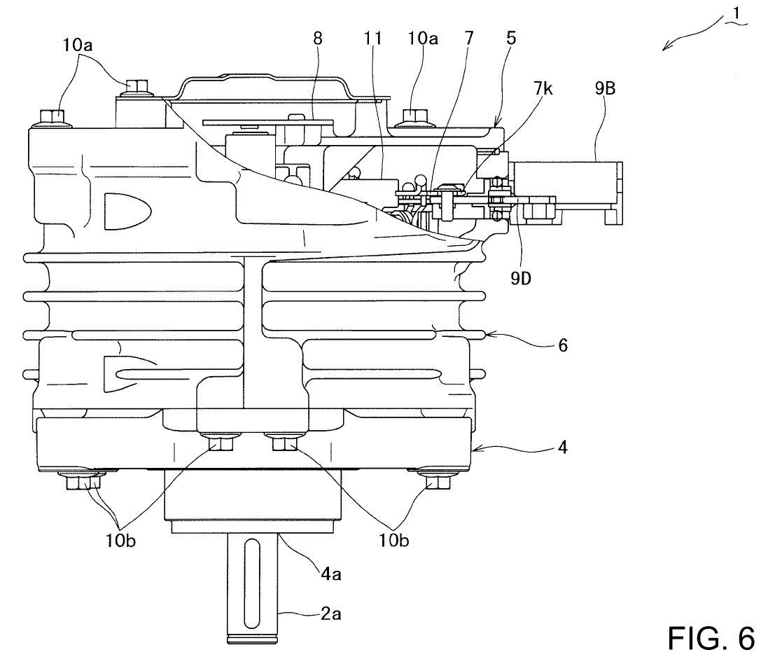

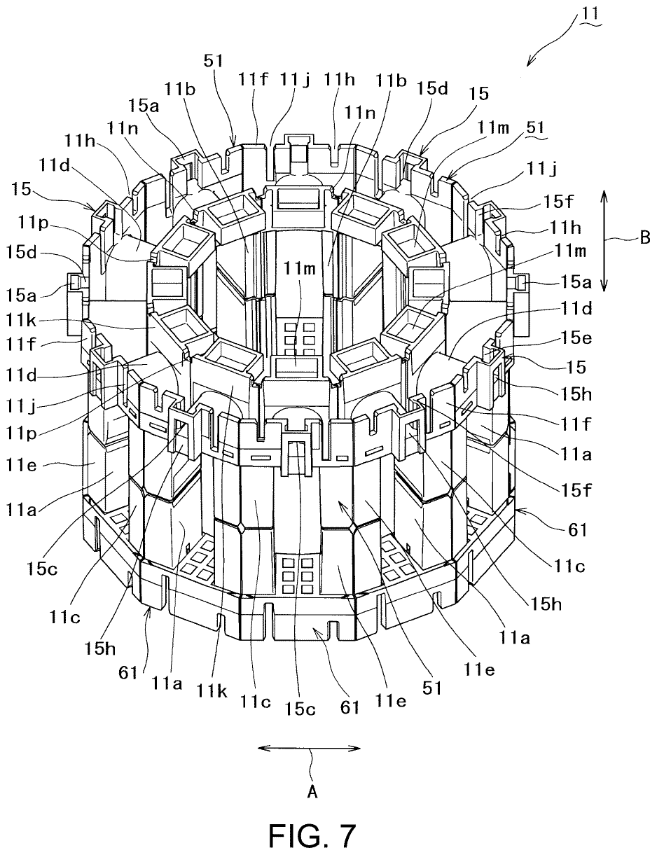

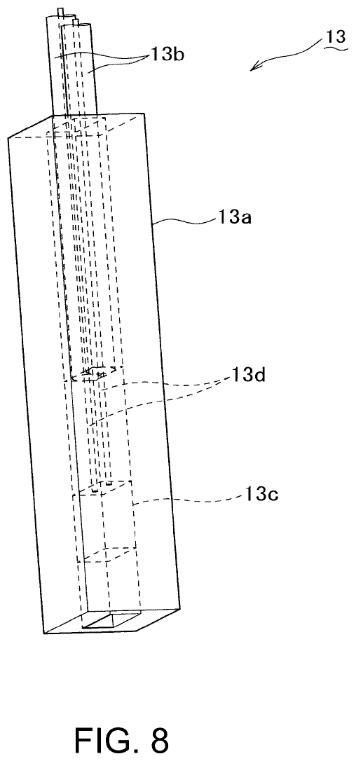

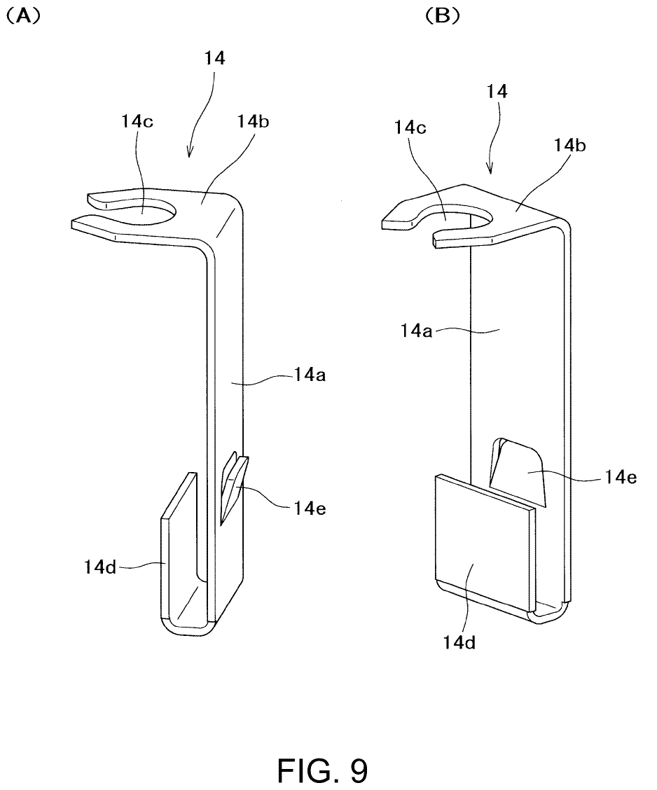

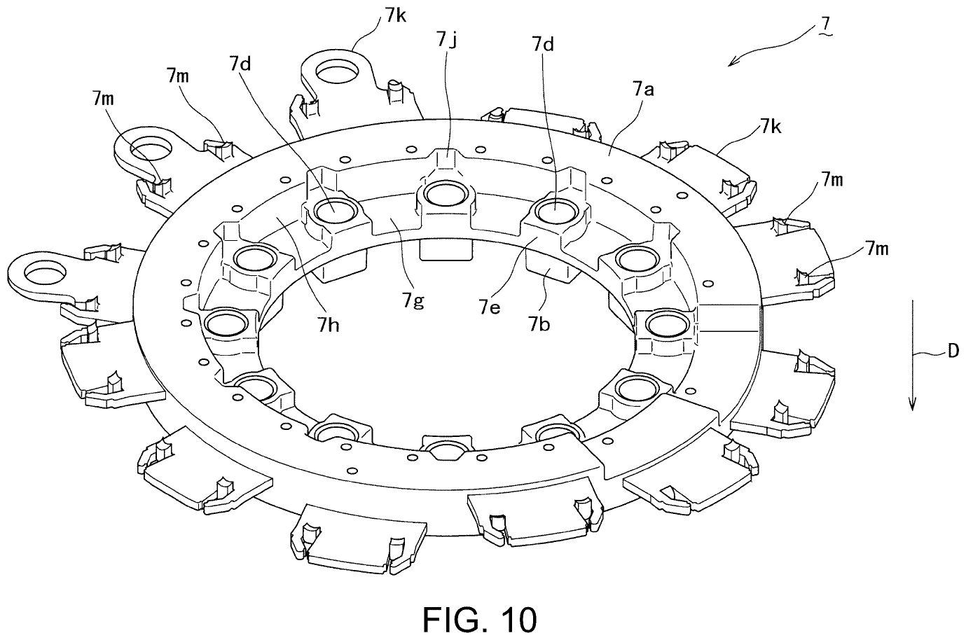

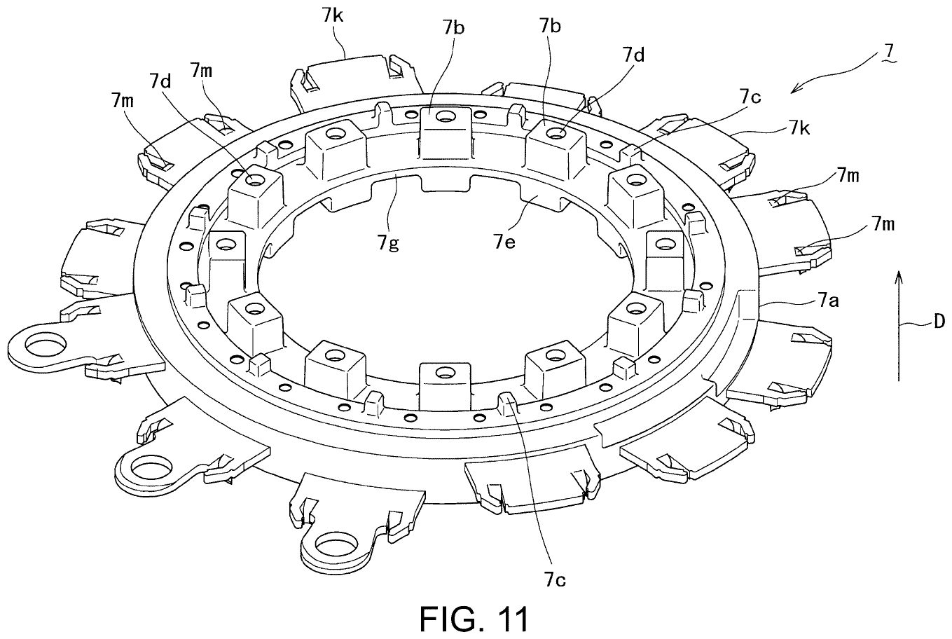

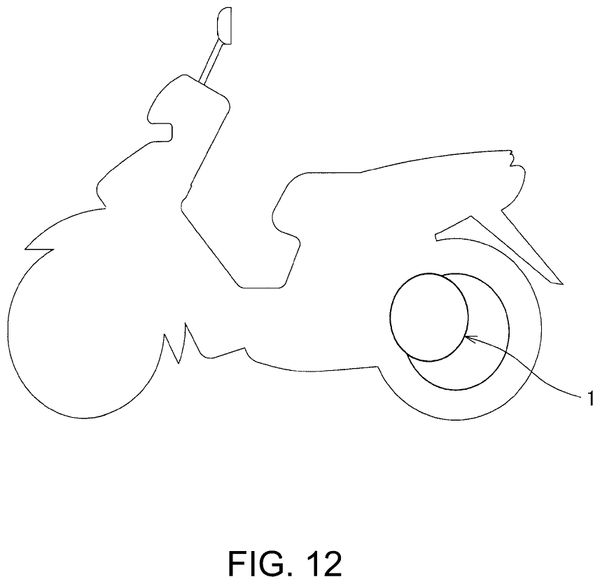

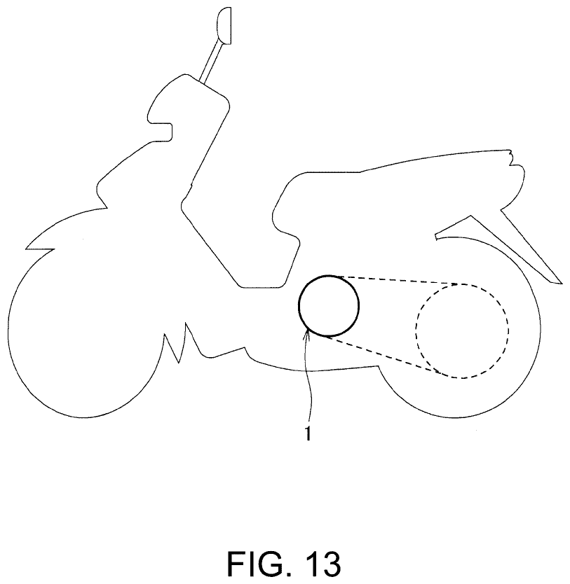

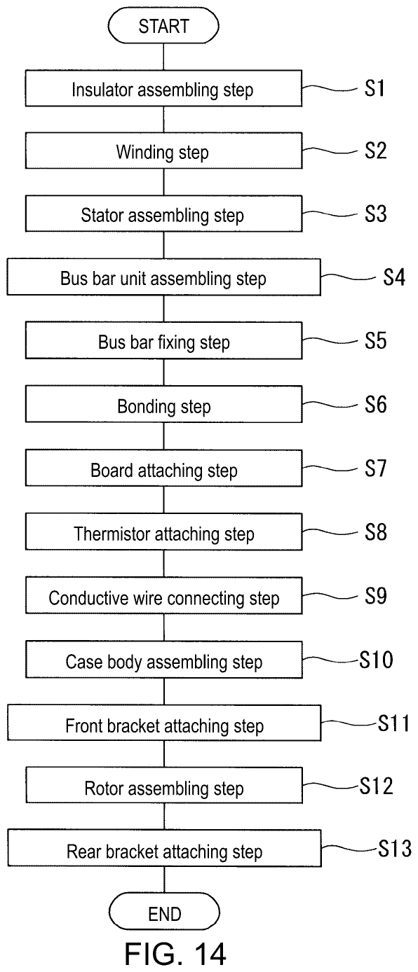

Hereinafter, one embodiment of the present invention will be described with reference to the drawings. FIG. 1 is a side view showing a motor according to an embodiment of the present invention. FIG. 2 is a cross-sectional view of the motor with a portion cut away in the axial direction. FIG. 3 is a partial perspective view of the motor. FIG. 4 is a partial radial cross-sectional view of the motor. FIG. 5 is a partial axial cross-sectional view of the motor. FIG. 6 is a side view of the motor with a portion cut away. FIG. 7 is a perspective view showing an insulator of the motor. FIG. 8 is a perspective view showing a thermistor of the motor. (A) and (B) of FIG. 9 are views showing a leaf spring material of the motor, wherein (A) is a perspective view from the outside and (B) is a perspective view from the inside. FIG. 10 is a perspective view showing a bus bar unit of the motor from the rear side. FIG. 11 is a perspective view showing the bus bar unit from the front side. FIG. 12 is a schematic view showing a state where the motor is attached to a side-mounted electric motorcycle. FIG. 13 is a schematic view showing a state where the motor is attached to a center-mounted electric motorcycle. FIG. 14 is a process diagram showing manufacturing steps of the motor.

### Overall Configuration

The motor 1 according to this embodiment is a three-phase motor called a brushless motor. The motor 1 is used, for example, as a drive motor for an electric motorcycle that is driven frequently and requires high durability. For example, the motor 1 is used as a drive motor for a side-mounted electric motorcycle that is driven beside the drive wheel as shown in FIG. 12, or a center-mounted electric motorcycle that is driven between the front wheel and the rear wheel as shown in FIG. 13.

Also, the motor 1 is an IPM motor (Interior Permanent Magnet Motor) in which a magnet (permanent magnet) is embedded in a rotor 2. Specifically, as shown in FIG. 2, the motor 1 includes a substantially cylindrical stator 3, and has an inner rotor type configuration in which the rotor 2 is concentrically and rotatably attached inside the stator 3. The rotor 2 is supported rotatably around a rotation shaft 2a. In the following description, unless otherwise specified, the circumferential direction, the axial direction, and the radial direction are defined based on the axis of the rotation shaft 2a.

A front bracket 4 and a rear bracket 5 serving as lids are attached to both axial ends of the stator 3, and a case body 6 serving as a housing is attached between the front bracket 4 and the rear bracket 5. The front bracket 4 is provided with an insertion hole 4a as an opening through which one end of the rotation shaft 2a of the rotor 2 is inserted and protrudes. In the following description, the side on which the front bracket 4 is located is defined as the front side, and the side on which the rear bracket 5 is located is defined as the rear side.

The case body 6 is formed in a substantially cylindrical shape with openings on both the front side and the rear side. As shown in FIG. 1 and FIG. 2, the motor 1 has a three-part structure composed of the front bracket 4, the rear bracket 5, and the case body 6. Then, in the motor 1, the stator 3 is installed and fixed inside the case body 6, and one end of the rotation shaft 2a protrudes from the insertion hole 4a of the front bracket 4 so that the rotation shaft 2a is fixed between the front bracket 4 and the rear bracket 5, and the rotor 2 is rotatable within the stator 3. An annular bus bar unit 7 is concentrically attached to the end portion on the rear side of the stator 3. A substantially rectangular flat plate-shaped rotation sensor board 8, to which a conductive wire (not shown) connected to a rotation sensor that detects the rotation speed of the rotor 2, for example, is connected, is attached to the rear side of the bus bar unit 7. The rotation sensor board 8 is attached at a position eccentric from the rotation center of the rotation shaft 2a. In addition, as shown in FIG. 5 and FIG. 6, an output connector 9A is attached to the outer peripheral portion of the case body 6 for drawing out each conductive wire connected to a connector 8a of the rotation sensor board 8. Furthermore, a terminal holder 9B is attached to the outer peripheral portion of the case body 6 to be adjacent to the output connector 9A. The terminal holder 9B is electrically connected to a predetermined bus bar terminal 7k of the bus bar unit 7 via a terminal 9D.

The stator 3 includes a stator core 3a formed by laminating a plurality of electromagnetic steel plates. The stator core 3a is press-fitted into the case body 6. Further, the front bracket 4 is fixed to the front side of the case body 6 by bolts 10a, and the rear bracket 5 is fixed to the rear side of the case body 6 by bolts 10b. The front bracket 4 and the rear bracket 5 are fixed to the case body 6 by separate bolts 10a and 10b. The stator core 3a includes a cylindrical stator core main body 3b and a plurality of teeth 3c protruding radially inward from the inner peripheral side of the stator core main body 3b. The teeth 3c are provided, for example, in a number of 12, and are provided at equal intervals in the circumferential direction. An insulator 11 is attached to each tooth 3c, and a winding coil 12 is wound around each tooth 3c via the insulator 11. The stator 3 is divided into 12 parts in the circumferential direction, and a part of the 12-part stator is configured as a stator member 31. The stator members 31 are formed in the same shape, each of which has one of the 12 divided parts of the stator core main body 3b and the tooth 3c. Further, concave and convex surfaces 31a that fit to each other are formed on the circumferential end surfaces of the portions of the stator members 31 that correspond to the stator core main body 3b. The stator 3 has a configuration that includes the insulator 11 and a total of 12 winding coils 12.

The insulator 11 is constituted by two parts made of insulating synthetic resin, and is mounted on the tooth 3c from both axial end sides of the motor 1, respectively. Further, the insulator 11 is formed to have an outer diameter smaller than the outer diameter of the stator 3. Specifically, the insulator 11 includes, for example, 24 insulator main bodies 11a, each of which has an inner periphery that is perforated in a rectangular shape and an outer periphery that is formed in an elliptical shape so as to cover the outer peripheral surface of the tooth 3c. The insulator 11 has a total of 24 insulator main bodies 11a arranged at equal intervals in the circumferential direction with the axial direction of the insulator main bodies 11a directed in the radial direction of the motor 1. Then, the insulator 11 is attached with the stator core main body 3b protruding from the outer peripheral side of each insulator main body 11.

An inner flange 11b is provided around the entire periphery at the peripheral edge of each insulator main body 11a on the stator core main body 3b side. Further, an outer flange 11c is provided around the entire periphery at the peripheral edge on the tip side of the tooth 3c, opposite to the inner flange 11b of the insulator main body 11a. Then, the insulator main body 11a, the inner flange 11b, and the outer flange 11c form a winding portion 11d for mounting the winding coil 12 thereon. The winding coil 12 is attached to each winding portion 11d, and is formed by winding a wire 12a from the inner peripheral side to the outer peripheral side multiple times. The winding coil 12 is attached to the winding portion 11d by winding the wire 12a with the radial direction as the central axis direction. As shown in FIG. 7, the winding portions 11d are spaced and arranged at equal intervals in the circumferential direction.

The wire 12a is a conductive rectangular wire having a rectangular cross section, and the surface is covered with an insulating material. The wire 12a is wound by bringing one side surface of the wire 12a into contact with the winding portion 11d, and then further laminated and wound while bringing one side surface of the wire 12a into contact with the other side surface of the wound wire 12a. Furthermore, the wire 12a is wound to be adjacent to and in contact with the already wound wire 12a while alternately changing the winding direction from the outer peripheral side to the inner peripheral side of the winding portion 11d and then from the inner peripheral side to the outer peripheral side. Then, the wire 12a is ultimately arranged to be adjacent in the radial direction and wound and aligned from the inner peripheral side to the outer peripheral side or from the outer peripheral side to the inner peripheral side of the winding portion 11d to form the winding coil 12.

The outer flange 11c of the insulator 11 has two side portions that come into contact with the stator core main body 3b of the stator core 3a and serve as flat plate-shaped stator core receiving portions 11e. Further, the outer flange 11c has an axial end portion that does not come into contact with the stator core main body 3b and serves as a flat plate-shaped outer wall portion 11f. The outer wall portion 11f is formed to be thicker than the stator core receiving portion 11e, and the outer surface of the outer wall portion 11f is formed in a flange shape that protrudes outward from the outer surface of the stator core receiving portion 11e. As a result, a step portion 11g is formed between the outer wall portion 11e and the stator core receiving portion 11, and the stator core main body 3b is fitted between the step portions 11g of the outer wall portions 11f located at both ends in the axial direction.

Each outer wall portion 11f of the insulator 11 has a width direction A respectively perpendicular to the axial direction and the radial direction, and is arranged in the circumferential direction to form a dodecagonal shape as viewed in the axial direction. A pair of winding fitting grooves 11h and 11j are provided at a predetermined distance from each other on the end surface on the rear side or the front side of each outer wall portion 11f. These winding fitting grooves 11h and 11j are formed in a concave groove shape that opens on the end surface side of the outer wall portion 11f and penetrates the outer wall portion 11f in the thickness direction. Then, one winding fitting groove 11h is shallower in the axial direction than the other winding fitting groove 11j, that is, formed in a small cutout shape.

When starting to wind the wire 12a around the winding portion 11d, a start point portion 12c on the base side of the wire 12a is fitted into one winding fitting groove 11h and temporarily fixed therein. An end point portion 12b protruding from the outer peripheral side of the wire 12a in a state where the winding coil 12 is formed by winding the wire 12a around the winding portion 11d is fitted into the other winding fitting groove 11j and temporarily fixed therein. That is, the winding coil 12 is configured by gradually winding the wire 12a onto the winding portion 11d from the inner layer side in a state where the start point portion 12c of the wire 12a is temporarily fixed in the winding fitting recess 11h, and then temporarily fixing the end point portion 12b of the wire 12a in the winding fitting recess 11j to draw out and guide the wire 12a to the outer peripheral side of the insulator 11.

Furthermore, as shown in FIG. 7, the insulator 11 is configured to be divided into two parts in the axial direction, the rear side one-half portion of the two parts is divided into 12 parts in the circumferential direction, and a part of the 12-part insulator 11 is configured as a rear side insulator member 51. The rear side insulator members 51 are formed in the same shape, each of which has the rear side half of the insulator main body 11a, the inner flange 11b, and the outer flange 11c. Furthermore, the front side one-half portion of the insulator 11, which is divided into two in the axial direction, is also divided into 12 parts in the circumferential direction, and a part of the 12-part insulator 11 is configured as a front side insulator member 61. The front side insulator members 61 are also formed in the same shape, each of which has the front side half of the insulator main body 11, the inner flange 11b, and the outer flange 11c.

### Fixing Configuration of the Insulator 11

An inner wall portion 11k is formed at the axial end portion of the inner flange 11b of each rear side insulator member 51 that faces the sensor attachment portion 15. The inner wall portion 11k is formed to be thicker than the stator core receiving portion 11e, and the inner surface of the inner wall portion 11k is formed in a flange shape that protrudes inward from the inner surface of the stator core receiving portion 11e. Then, an insertion receiving portion 11m that protrudes in the radially inner direction is provided on the inside of the inner wall portion 11k. As shown in FIG. 3, FIG. 4, and FIG. 7, the insertion receiving portion 11m is formed in a tray shape having a concave cross section and an opening on the rear side. The insertion receiving portion 11m is provided on each rear side insulator member 51, and a total of 12 insertion receiving portions 11m are arranged at equal intervals in the circumferential direction of the insulator 11. Furthermore, each insertion receiving portion 11m is provided to protrude in the radially inner direction to a position covering a part of the rotor 2, that is, the outer peripheral edge of the rotor 2, in a state where the rotor 2 is attached to the stator 3.

In addition, both end portions of the inner wall portion 11k of each rear side insulator member 51 in the width direction A are cut out to form fitting step portions 11n. The fitting step portions 11n are provided at the corners on the rear side of the inner wall portion 11k, and in a state where a total of 12 rear side insulator members 51 are assembled, the adjacent fitting step portions 11n form a concave fitting groove 11p. In short, the fitting groove 11p is located between the insertion receiving portions 11m of the insulator 11, and a total of 12 fitting grooves 11p are arranged at equal intervals in the circumferential direction on the rear side of the insulator 11.

The bus bar unit 7 is concentrically fixed to the rear side of the insulator 11. The bus bar unit 7 supplies power to each winding coil 12, and includes a substantially annular bus bar unit main body 7a, as shown in FIG. 4, FIG. 10, and FIG. 11. An insertion fixing portion 7b serving as an insulator fixing portion to be inserted into the insertion receiving portion 11m of the insulator 11 is provided at a position on the inner peripheral side of the bus bar unit main body 7a near the front side. The bus bar unit main body 7a is formed to be thicker than the insertion fixing portion 7b in the axial direction. The insertion fixing portion 7b is formed in a protruding rectangular column shape that protrudes to the front side and is inserted into the insertion receiving portion 11m from the rear side. A total of 12 insertion fixing portions 7b are arranged at equal intervals in the circumferential direction. Furthermore, in a state where the rotor 2 is disposed on the outer periphery of the stator 3, each insertion fixing portion 7b is provided to protrude in the radially inner direction to a position covering a part of the rotor 2, that is, the outer peripheral edge of the rotor 2.

As shown in FIG. 11, a total of 12 locking protrusions 7c are provided on the bottom surface portion located on the front side of the bus bar unit main body 7a. The locking protrusions 7c are configured to fit into the fitting grooves 11p of the insulator 11 when the bus bar unit 7 is concentrically fixed to the rear side of the insulator 11. The bus bar unit 7 is formed with a predetermined clearance so that the bottom surface on the front side of the bus bar unit 7 does not contact the surface on the rear side of the winding coil 12. The locking protrusion 7c facilitates the alignment of the bus bar unit 7 with respect to the insulator 11 in the circumferential direction, and fixes the position by restricting the rotational movement of the bus bar unit 7 with respect to the insulator 11.

Furthermore, the bus bar unit 7 is configured so that, as shown in FIG. 4, a predetermined gap C serving as an adhesive point is formed between the bottom surface on the front side of the insertion fixing portion 7b of the bus bar unit 7 and the bottom surface of the insertion receiving portion 11m of the insulator 11 in a state where the bus bar unit 7 is positioned and fixed by fitting the locking protrusions 7c of the bus bar unit 7 into the fitting grooves 11p of the insulator 11 and inserting the insertion fixing portions 7b of the bus bar unit 7 into the insertion receiving portions 11m of the insulator 11.

Also, a leg portion 7e having a through hole 7d penetrating into each insertion fixing portion 7b is provided on the rear side of each insertion fixing portion 7b of the bus bar unit main body 7a. The leg portion 7e protrudes further toward the inner peripheral side of the bus bar unit main body 7a than the insertion fixing portion 7b. The through hole 7d penetrates from the rear side of the leg portion 7e to the front side of the insertion fixing portion 7b, and is formed in a conical shape, that is, a funnel shape with a decreasing diameter in the insertion direction D in which the insertion receiving portion 11m of the insulator 11 is inserted into the insertion fixing portion 7b. Further, the through hole 7d has a length that is the sum of the thickness of the leg portion 7e and the thickness of the insertion fixing portion 7b, and the internal volume of the through hole 7d is designed to be larger than the amount of an adhesive 7f filled into the through hole 7d. Then, as shown in FIG. 4, the through hole 7d functions as an adhesive filling port for filling the adhesive 7f having fluidity from the rear side into the gap C between the insertion fixing portion 7b and the insertion receiving portion 11m, immersing the side surface of the insertion fixing portion 7b in the adhesive 7f, and adhesively fixing the insertion fixing portion 7b and the insertion receiving portion 11m.

In addition, the leg portions 7e are connected in the circumferential direction by flat plate-shaped inner flange portions 7g and protrude further toward the rear side than the inner flange portions 7g. Each inner flange portion 7g forms a step portion 7h with the inner peripheral surface of the bus bar unit main body 7a. Then, a concave step portion 7j, which is formed by recessing the inner peripheral surface of the bus bar unit main body 7a into a concave shape, is formed in a portion of the step portion 7h on the outer peripheral side of the leg portion 7e.

A flange-shaped bus bar terminal 7k serving as a coil connection portion for positioning and fixing the start point portion 12c and the end point portion 12b of each winding coil 12 is provided on the outer peripheral portion of the bus bar unit main body 7a. Each bus bar terminal 7k protrudes to the outer peripheral side along the radial direction, and the same as the number of the winding coils 12, a total of 12 bus bar terminals 7k are provided and arranged at equal intervals in the circumferential direction. A pair of connection portions 7m are provided on the outer peripheral edge of each bus bar terminal 7k, to which the start point portion 12c or the end point portion 12b of the winding coil 12 is welded and electrically connected.

### Temperature Detection Configuration

A thermistor 13 for detecting the temperature of the winding coil 12 and a leaf spring material 14 for urging the thermistor 13 against the winding coil 12 are attached to the outer periphery of the insulator 11. The thermistor 13 and the leaf spring material 14 are attached to a thermistor housing portion 15 provided on the outside of the outer wall portion 11f located on the rear side of the insulator 11. In short, the thermistor housing portion 15 is provided in each of the rear side insulator members 51. Then, the thermistor housing portion 15 is provided between a pair of winding fitting grooves 11h and 11j located on the outside of the outer wall portion 11f at the center position in the width direction of the outer surface of the outer wall portion 11f. That is, the thermistor housing portion 15 is located between the start point portion 12c and the end point portion 12b of the winding coil 12.

Furthermore, the thermistor housing portion 15 has a mounting recess 15a into which the thermistor 13 is fitted from the rear side. The mounting recess 15a is provided along the axial direction and is formed in a box shape protruding toward the outer peripheral side of the insulator 11, that is, the outside of the outer wall portion 11f. Further, the mounting recess 15a is provided from the end portion on the rear side of the outer wall portion 11f to a position along the outer peripheral surface of the winding portion 11d. In addition, as shown in FIG. 3 and FIG. 4, the mounting recess 15a has a function of preventing the insulator 11 from falling over by bringing the bottom portion on the front side of the mounting recess 15a into contact with the surface on the rear side of the stator core main body 3b.

A locking groove 15b penetrating the mounting recess 15a is provided on the outer surface of the mounting recess 15a. The locking groove 15b is formed in a rectangular shape, and the opening edge on the rear side forms a locking surface 15c that is perpendicular to the outer wall portion 11f. Further, a housing recess 15d having a concave cross section is provided on the insulator main body 11a side of the outer surface of the mounting recess 15a. The housing recess 15d is provided continuously on the insulator main body 11a side of the locking groove 15b. In addition, the housing recess 15d is provided from the opening edge located opposite to the locking surface 15c of the housing recess 15d to an end portion on the rear side in the height direction perpendicular to the width direction A.

The thermistor housing portion 15 is also formed with an opening 15e for bringing the thermistor 13 attached to the mounting recess 15a into direct contact with the winding coil 12. The opening 15e penetrates to the rear side and is formed with a width slightly smaller than the width of the mounting recess 15a. In addition, the opening 15e has a shape formed by cutting the portion from the end portion on the rear side of the outer wall portion 11f to the outer peripheral surface of the winding portion 11d into a concave shape. The opening 15e is provided at the center position in the width direction A along the axial direction. Therefore, the opening 15e is provided at the center position in the width direction A of the winding coil 12 wound around the winding portion 11d along the lamination direction B, which is the winding direction of the wire 12a of the winding coil 12. As a result, the thermistor 13 is attached to the thermistor housing portion 15 to extend from the opening 15e along the lamination direction B of the winding coil 12 and come into contact with the plurality of wires 12a located in the inner layer of the winding coil 12.

Then, locking pieces 15f which are protruding inner pieces of the mounting recess 15a are provided at both sides of the opening 15e in the width direction A. The locking pieces 15f are located near both sides of the thermistor 13 attached to the mounting recess 15a, and restrict the movement of the thermistor 13 in the width direction A.

As shown in FIG. 8, the thermistor 13 includes a thermistor main body 13a having an elongated rectangular cross section. The thermistor 13 has a configuration in which a pair of conductive wires 13b are led out from one end side in the longitudinal direction of the thermistor main body 13a. Then, a detection element 13c that serves as a base point for detecting temperature is housed inside the thermistor main body 13a. The detection element 13c is attached at a position on one end side spaced a predetermined distance from the other end surface of the thermistor main body 13a. Besides, a pair of lead wires 13d are connected to one end side of the detection element 13c in the longitudinal direction of the thermistor main body 13a. Then, the end portions of the pair of lead wires 13d are electrically connected to the pair of conductive wires 13b.

The leaf spring material 14 is an urging member that urges the thermistor 13 against the winding coil 12. As shown in (A) and (B) of FIG. 9, the leaf spring material 14 includes a thin, long, flat plate-shaped leaf spring body 14a. The leaf spring body 14a has one end side bent into an L shape and the other end side bent into a V shape in the same direction as the one end side, and is configured to have an elastic force for urging the thermistor 13 against the winding coil 12. An L-shaped bent portion 14b on one end side of the leaf spring body 14a is provided with a concave insertion recess 14c for inserting the conductive wire 13a protruding from the thermistor 13. The bent portion 14b is configured to insert the conductive wire 13b of the thermistor 13 into the insertion recess 14c and hold the base end side of the thermistor main body 13b of the thermistor 13 attached to the thermistor housing portion 15.

On the other hand, a U-shaped elastic piece 14d on the other end side of the leaf spring 14a is inserted into the mounting recess 15a of the thermistor housing portion 15 together with the thermistor 13, and locks the thermistor 13. The elastic piece 14d is configured to urge the thermistor 13 attached to the thermistor housing portion 15 toward the winding coil 12 side by the elastic force of the elastic piece 14d. Furthermore, a retaining piece 14e is provided in the intermediate portion in the longitudinal direction of the leaf spring body 14a to protrude opposite to the bending direction of the bent portion 14b. The retaining piece 14e is formed by cutting a part of the leaf spring body 14a. Then, the retaining piece 14e has a so-called snap-fit configuration that is locked to the locking surface 15c of the thermistor housing portion 15 to retain the thermistor 13 from coming out of the thermistor housing portion 15 when the leaf spring material 14 is fitted together with the thermistor 13 into the mounting recess 15a of the thermistor housing portion 15.

Furthermore, as shown in FIG. 2, one thermistor 13 and one leaf spring material 14 are attached to only one thermistor housing portion 15 of the multiple rear side insulator members 51 of the insulator 11. The thermistor 13 is configured to detect the temperature of one adjacent winding coil 12 among the plurality of winding coils 12. Here, one output side of the conductive wire 13b of the thermistor 13 is routed to the output connector 9A and led out to the outside, as shown in FIG. 5. Further, the other ground side of the conductive wire 13b is electrically connected to the rotation sensor board 8 via the connector 8a. Therefore, from the viewpoint of shortening the length of the conductive wire 13b and considering the routing of the conductive wire 13b, the thermistor 13 is attached to the thermistor housing portion 15 adjacent to each of the connector 8a of the rotation sensor board 8 and the output connector 9A.

In addition, the thermistor 13 is press-fitted together with the leaf spring material 14 into the thermistor housing portion 15 and stored therein. Then, the thermistor 13 is pressed toward the winding coil 12 side by the elastic force of the leaf spring material 14 generated between the thermistor 13 and the outer peripheral surface of the thermistor housing portion 15, and the thermistor 13 comes into contact with the wire 12a located on the inner peripheral side of the winding coil 12 from the opening 15e of the thermistor housing portion 15. Furthermore, the thermistor 13 is fixed in contact with the plurality of wires 12a located on the inner layer side of the winding coil 12.

### Manufacturing Method

Next, manufacturing steps of a manufacturing method for the motor 1 according to the above embodiment will be described with reference to FIG. 14.

### Insulator Assembling Step

First, the insulator 11 is attached to the stator core 3a. At this time, the rear side insulator member 51 and the front side insulator member 61 are combined to form one winding portion 11d (S1).

### Winding Step

In this state, the winding coil 12 is mounted by winding the wire 12a around the winding portion 11d (S2).

### Stator Assembling Step

Next, a total of 12 units are prepared by combining the rear side insulator member 51 and the front side insulator member 61, mounting the winding coil 12, and fitting the stator member 31 thereto. Then, these 12 units are arranged in an arc shape with the respective outer wall portion 11f sides facing the outer peripheral side. At this time, the opposing concave and convex surfaces 31a of adjacent stator members 31 are fitted together to form the arc-shaped stator 3 (S3).

### Bus Bar Unit Assembling Step

Thereafter, the bus bar unit 7 is assembled to the rear side of the insulator 11 (S4). At this time, the respective insertion fixing portions 7b of the bus bar unit 7 are inserted into the respective insertion receiving portions 11m of the insulator 11, and the respective locking protrusions 7c of the bus bar unit 7 are fitted into the respective fitting grooves 11p of the insulator 11.

### Bus Bar Fixing Step

Next, the start point portion 12c and the end point portion 12b of each winding coil 12 attached to the insulator 11 are fixed by welding to the connection portion 7m of each bus bar terminal 7k of the bus bar unit 7, and the start point portion 12c and the end point portion 12b of each winding coil 12 are electrically connected to the predetermined bus bar terminal 7k (S5).

### Bonding Step

In this state, a predetermined amount of adhesive 7f is injected into each through hole 7d of the bus bar unit 7, the adhesive 7f is filled into the gap C formed between the insertion fixing portion 7b of the bus bar unit 7 and the insertion receiving portion 11m of the insulator 11 and hardened, and the insertion fixing portion 7b of the bus bar unit 7 and the insertion receiving portion 11m of the insulator 11 are bonded and fixed by the adhesive 7f(S6 ).

### Board Attaching Step

Thereafter, the rotation sensor board 8 is attached to the bus bar unit 7 (S7).

### Thermistor Attaching Step

Next, the base end portion of the conductive wire 13b of the thermistor 13 is inserted into the insertion recess 14c of the leaf spring material 14. Then, the leaf spring body 14a of the leaf spring material 14 is placed adjacent to the outside of the thermistor main body 13a of the thermistor 13. In this state, starting with the elastic piece 14d side of the leaf spring material 14, the thermistor 13 and the leaf spring material 14 are press-fitted into the mounting recess 15a of the thermistor housing portion 15 located adjacent to the rotation sensor board 8. At this time, the retaining pieces 14e of the leaf spring material 14 engages with the locking surfaces 15c of the thermistor housing portion 15, so that the thermistor 13 is held in the thermistor housing portion 15 and prevented from coming out (S8).

In the thermistor housing portion 15, the elastic piece 14d of the leaf spring material 14 is pressed between the outer surface of the mounting recess 15a and the thermistor 13, and is elastically deformed. Then, the elastic force of the elastic piece 14f presses the thermistor 13 toward the winding coil 12 side, which brings the thermistor 13 into direct contact with the plurality of wires 12a located on the inner peripheral side of the winding coil 12 through the opening 15e of the thermistor housing portion 15.

Conductive Wire Connecting Step

Then, one output side of the conductive wire 13b of the thermistor 13 is routed to the output connector 9A and led out to the outside, and the other ground side of the conductive wire 13b is electrically connected to the rotation sensor board 8 via the connector 8a (S9).

### Case Body Assembling Step

Thereafter, the stator 3 and the insulator 11 are attached to the case body 6 (S10).

### Front Bracket Attaching Step

Next, the front bracket 4 is attached to the front side of the case body 6, and the front bracket 4 is fixed to the case body 6 with the bolts 10a (S11).

### Rotor Assembling Step

Furthermore, the rotor 2 is inserted into the stator 3 from the rear side (S12).

### Rear Bracket Attaching Step

Thereafter, the rear bracket 5 is attached to the rear side of the stator 3, and then the rear bracket 5 is fixed to the case body 6 with the bolts 10b (S13).

### Effect

As described above, the motor 1 according to the above embodiment has a configuration in which the bus bar unit 7 is concentrically fixed to the rear side of the insulator 11. Therefore, the bus bar unit 7 can be firmly fixed to the insulator 11, so vibration that may occur when the motor 1 is driven can be appropriately suppressed.

In particular, a plurality of insertion receiving portions 11m are provided on the inner peripheral side of the insulator 11 and a plurality of insertion fixing portions 7b are provided on the inner peripheral side of the bus bar unit 7, and these insertion fixing portions 7b are inserted into the insertion receiving portions 11m and then fixed with the adhesive 7f. Since the stress applied to the connection portion 7m between the bus bar terminal 7k and the start point portion 12c and the end point portion 12b of the winding coil 12 can be reduced, it is possible to prevent the connection portion 7m from breaking due to stress when the bus bar unit 7 is fixed to the insulator 11.

Further, the configuration is provided with the insertion receiving portion 11m protruding in the radially inner direction of the insulator 11 and the insertion fixing portion 7b protruding in the radially inner direction of the bus bar unit 7. Therefore, even if the start point portion 12c, which is the winding start portion of the winding coil 12, and the end point portion 12b, which is the lead-out portion, are respectively protruded toward the radially outer side of the insulator 11, or the shape of the winding 12 as viewed in the axial direction is substantially sector-shaped in order to improve the space factor of the winding coil 12, the connection portion 7m between the bus bar terminal 7k and the start point portion 12c and the end point portion 12b of the winding coil 12 can be disposed without interfering with the insertion receiving portion 11mof the insulator 11 and the insertion fixing portion 7b of the bus bar unit 7 in terms of layout.

Moreover, the through hole 7d is provided in the insertion fixing portion 7b of the bus bar unit 7, and the adhesive 7f flows in from the through hole 7d to adhesively fix the insertion fixing portion 7b of the bus bar unit 7 to the insertion receiving portion 11m of the insulator 11. Therefore, after assembling the bus bar unit 7 to the insulator 11 and then welding and fixing the start point portion 12c and the end point portion 12b of each winding coil 12 to the connection portion 7m of each bus bar terminal 7k of the bus bar unit 7, the bus bar unit 7 can be fixed to the insulator 11 by applying the adhesive 7f to the through hole 7d. As a result, for example, compared to a case where the adhesive 7f is applied and then, before the adhesive 7f hardens, the start point portion 12c and the end point portion 12b of the winding coil 12 are crimped and welded after the bus bar unit 7 is assembled to the insulator 11, it is easier to predict and control the behavior of the fluid adhesive 7f, making it easier to prevent problems such as insufficient adhesive area. Furthermore, compared to a case where the bus bar unit 7 is fixed to the insulator 11 by screws or the like, it is possible to reduce the number of steps for assembling the bus bar unit 7, thereby reducing the costs of the motor 1.

Further, the insertion receiving portion 11m of the insulator 11 and the insertion fixing portion 7b of the bus bar unit 7 are respectively protruded toward the radially inner side to a position covering a part of the rotor 2. In short, the insertion receiving portion 11m and the insertion fixing portion 7b are arranged to overlap the rotor 2 when viewed in the axial direction. As a result, the insertion fixing portion 7b is inserted into the insertion receiving portion 11m and fixed, so the fixing structure of the insertion receiving portion 11m and the insertion fixing portion 7b can be ensured to be larger in the radial direction. Thus, the bus bar unit 7 can be fixed to the insulator 11 more firmly.

Also, since the insertion receiving portion 11m and the insertion fixing portion 7b are respectively protruded toward the radially inner side to a position covering a part of the rotor 2, the rotor 2 cannot be assembled from the rear side of the stator 3. Thus, in order to allow the rotor 2 to be assembled from the front side of the stator 3, the motor 1 has a three-part structure composed of the front bracket 4, the rear bracket 5, and the case body 6. As a result, by appropriately changing the structure of the front bracket 4 to fit the object to which the motor 1 is than the front bracket 4. Therefore, simply by redesigning the front bracket 4, the motor 1 can be adapted to be even a drive motor for a side-mounted electric motorcycle as shown in FIG. 12 or a center-mounted electric motorcycle as shown in FIG. 13, for example, which can greatly improve the versatility of the motor 1.

Furthermore, a plurality of the insertion receiving portions 11m and a plurality of the insertion fixing portions 7b are arranged at equal intervals in the circumferential direction of the insulator 11 and the bus bar unit 7, respectively. Therefore, the bus bar unit 7 can be fixed to the insulator 11 at a plurality of points along the circumferential direction on the inner peripheral side by the insertion receiving portions 11m and the insertion fixing portions 7b, so the bus bar unit 7 can be firmly fixed to the insulator 11 in the circumferential direction. Further, the insertion receiving portion 11m of the insulator 11 is formed in a concave shape, and the insertion fixing portion 7b of the bus bar unit 7 is inserted into the insertion receiving portion 11m. Therefore, the configuration for fixing the bus bar unit 7 to the insulator 11 can be simplified, and the work of assembling the bus bar unit 7 to the insulator 11 can be simplified. Thus, the assemblability of the bus bar unit 7 can be improved.

In addition, by forming the through hole 7d of the bus bar unit 7 in a funnel shape with a decreasing diameter in the insertion direction D, it is possible to improve the demoldability in the case of manufacturing the synthetic resin bus bar unit 7 by injection molding or the like. Then, since the portion of the through hole 7d on the inlet side where the adhesive 7f is applied is widened, the bus bar unit 7 can be appropriately fixed to the insulator 11 by a dispenser that applies the adhesive 7f.

Furthermore, by making the axial thickness of the bus bar unit main body 7a of the bus bar unit 7 larger than that of the insertion fixing portion 7b, the upper leg portion 7e of the insertion fixing portion 7b can protrude upward, so it is possible to secure the internal volume of the through hole 7d. Then, by setting the internal volume of the through hole 7d to be larger than the amount of the adhesive 7f to be applied, it is possible to prevent the adhesive 7f from overflowing out of the through hole 7d.

In addition, by providing the flat plate-shaped inner flange portion 7g in the bus bar unit 7, it is possible to prevent the adhesive 7f injected from the through hole 7d from dripping to the inside of the motor 1, such as the rotor 2. Then, by connecting the leg portions 7e of the bus bar unit 7 in the circumferential direction with the inner flange portions 7g, the rigidity of the bus bar unit can be improved, and durability against vibration and impact can be improved. This is particularly advantageous when applied to an electric motorcycle where dealing with vibration is important.

Moreover, in the motor 1 according to the above embodiment, the thermistor housing portion 15 is provided at the center position in the width direction A on the outside of the outer wall portion 11f of the insulator 11, and the opening 15e is formed in the thermistor housing portion 15 along the lamination direction B of the winding coil 12. Then, by attaching the thermistor 13 in the thermistor housing portion 15, the thermistor 13 is located at the center position in the width direction B of the winding coil 12 and is in direct contact with the plurality of wires 12a on the inner layer side of the winding coil 12 in the lamination direction B.

As a result, the temperature of the wire 12a on the inner peripheral side in the lamination direction B of the winding coil 12, where heat is most likely to accumulate when the motor 1 is driven and which is likely to become a high-temperature area, can be detected by the thermistor 13 from outside the winding coil 12, and the temperature of the winding coil 12 can be detected with high accuracy. Thus, it is possible to appropriately suppress the occurrence of malfunctions and burnout failures due to melting of the insulator 11 and peeling of the coating of the winding coil 12, which may occur when the motor 1 reaches a high temperature, and to prevent damage to the motor 1.

In short, unlike the conventional motor in which the thermistor 13 is disposed within the winding coil 12 by winding the thermistor 13 when winding the wire 12a around the winding portion 12 of the insulator 11, and the thermistor 13 is attached to the surface of the winding coil 12, the motor 1 is configured by protruding the thermistor housing portion 15 to the outer periphery of the insulator 11. Therefore, it is no longer necessary to wind the thermistor 13 around the wire 12a of the winding coil 12, so the radial size of the periphery of the winding coil 12 of the motor 1 can be reduced, and the motor 1 can be made smaller in the radial direction, that is, thinner. Then, the temperature of the winding coil 12 can be accurately detected without reducing the space for winding the wire 12a of the insulator 11.

Also, the thermistor housing portion 15 is protruded from the outer surface of the outer wall portion 11f of the insulator 11, and the thermistor 13 is fitted into the thermistor housing portion 15 and fixed therein. Therefore, it is possible to reduce physical interference with the stator 3, the insulator 11, etc. that may occur when the thermistor 13 is attached and fixed in the thermistor housing portion 15. Thus, the work of assembling the thermistor 13 can be facilitated without compromising the assemblability of the stator core 3a. Further, the thermistor housing portion 15 is protruded toward the outside of the outer wall portion 11f without increasing the radial thickness of the outer wall portion 11f itself of the insulator 11. Therefore, the outer wall portion 11f of the insulator 11 can be made thin, so that deformation during molding can be suppressed even if the insulator 11 is made of synthetic resin. Thus, the insulator 11 can be molded with high precision, and the assemblability of the thermistor 13 can be improved without reducing the assemblability of the stator core 3a.

Furthermore, the configuration has the thermistor housing portion 15 provided on the outer peripheral side of each of the 12 winding portions 11d of the insulator 11. As a result, the thermistor housing portion 15 is provided for each of the 12 rear side insulator members 51 in the circumferential direction, and the rear side insulator members 15 can have the same shape. Thus, even though the insulator 11 is divided into 12 parts in the circumferential direction, the rear side insulator members 51 constituting the insulator 11 can be made common, thereby improving the manufacturability of the insulator 11.

Moreover, the thermistor housing portion 15 is provided between the winding fitting grooves 11h and 11j of the insulator 11. Therefore, the thermistor housing portion 15 can reinforce the center position in the width direction A of the outer wall portion 11f of the insulator 11, which tends to be a weak part, that is, the portion between the winding fitting grooves 11h and 11j. Thus, the rigidity of the outer wall portion 11f of the insulator 11, and therefore the rigidity of the insulator 11 itself, can be improved. Therefore, it is possible to suppress distortion of the insulator 11 that may occur in the case where stress is applied to the outer wall portion 11f of the insulator 11 when winding the wire 12a around the winding portion 11d of the insulator 11.

Furthermore, the wire 12a is a rectangular wire, and the winding coil 12 is formed by aligned winding that winds the wire 12a by bringing one side surface of the wire 12a into contact with the winding portion 11d and then laminates the wire 12a while bringing one side surface of the wire 12a into contact with the other side surface of the wound wire 12a. As a result, compared to a case where the wire 12a is a round wire, the thermistor 13 can be brought into contact with the multiple wires 12a located on the inner layer side of the winding coil 12, and the contact area between the wire 12a and the thermistor 13 can be increased. Thus, the temperature of the winding coil 12 can be accurately detected by the thermistor 13.

In addition, the thermistor 13 is press-fitted together with the leaf spring material 14 into the thermistor housing portion 15 of the insulator 11 and stored therein, and the elastic force of the leaf spring material 14 presses the thermistor 13 against the winding coil 12 to urge and bring the thermistor 13 into contact with the wire 12a on the inner layer side of the winding coil 12 through the opening 15e of the thermistor housing portion 15. As a result, no space is created between the thermistor 13 and the winding coil 12, and even if external impact is received or vibration occurs when the motor 1 is driven, the impact or vibration can be absorbed by the elastic force of the leaf spring material 14. Therefore, the elastic force of the leaf spring material 14 can prevent a space from being created between the thermistor 13 and the winding coil 12 and prevent the thermistor 13 from shifting. Thus, the temperature of the winding coil 12 can be detected appropriately by the thermistor 13.

Furthermore, the base end portion of the conductive wire 13b of the thermistor 13 is inserted into the insertion recess 14c of the leaf spring material 14, and when the thermistor 13 is press-fitted together with the leaf spring material 14 into the mounting recess 15a of the thermistor housing portion 15, a snap-fit structure is formed for the retaining piece 14e of the leaf spring material 14 to engage with the locking surface 15c of the thermistor housing portion 15. As a result, the thermistor 13 is retained and held by the leaf spring material 14 from coming out of the thermistor housing portion 15. Thus, a separate process for retaining the thermistor 13 in the thermistor housing portion 15, such as applying an adhesive or assembling a separate member, is not required. Therefore, the thermistor 13 can be easily attached to the insulator 11, and the assemblability of the thermistor 13 can be greatly improved.

In particular, the thermistor 13 is retained and held in the thermistor housing portion 15 of the insulator 11 so as not to come out, and one leaf spring material 14 is used as a member for urging and bringing the thermistor 13 fixed in the thermistor housing portion 15 into contact with the winding coil 12. Therefore, the configuration for urging the thermistor 13 toward the winding coil 12 and the configuration for retaining and holding the thermistor 13 from coming out of the thermistor housing portion 15 can be appropriately realized by using one relatively simple member, that is, the leaf spring material 14.

Based on the above, the motor 1 according to the present invention contributes to achieving the SDGs such as “Goal 9: Industry, Innovation and Infrastructure” and “Goal 12: Responsible Consumption and Production.”

Nevertheless, the present invention is not limited to the above embodiment, but includes various modifications. For example, the above embodiment has been described in order to easily explain the present invention, and the present invention does not necessarily have all the configurations described.

For example, the motor 1 according to the above embodiment can be used not only as a drive motor for a side-mounted electric motorcycle as shown in FIG. 12 or a center-mounted electric motorcycle as shown in FIG. 13, but also as the power for various electric devices that have suitable driving force, such as an in-wheel electric motorcycle that is driven in the wheel and a small electric car.

Further, in the above embodiment, the motor 1 is configured to use the leaf spring material 14 to retain the thermistor 13 in the thermistor attaching portion 15 of the insulator 11 and press the thermistor 13 against the winding coil 12, but for example, the thermistor 13 may be fixed to the thermistor attaching portion 15 using an adhesive, or the thermistor 13 may be fixed to the thermistor attaching portion 15 by screws.

Moreover, as long as the configuration can suppress deformation of the bus bar unit 7 due to resonance, the bus bar unit 7 can be fixed to the insulator 11 by using bolts, press fitting, or the like, without using the adhesive 7f.

### REFERENCE SIGNS LIST

1 motor
2 rotor
2a rotation shaft
3 stator
3a stator core
3b stator core main body
3c teeth
4 front bracket
4a insertion hole
5 rear bracket
6 case body
7 bus bar unit
7a bus bar unit main body
7b insertion fixing portion (fixing portion)
7c locking protrusion
7d through hole
7e leg portion
7f adhesive
7g inner flange portion
7h step portion
7j concave step portion
7k bus bar terminal
7m connection portion
8 rotation sensor board
8a connector
9A output connector
9B terminal holder
9D terminal
10a, 10b bolt
11 insulator
11a insulator main body
11b inner flange
11c outer flange
11d winding portion
11e stator core receiving portion
11f outer wall portion
11h, 11j winding fitting groove
11k inner wall portion
11m insertion receiving portion (receiving portion)
11n fitting step portion
11p fitting groove
12 winding coil
12a wire
12b end point portion
12c start point portion
13 thermistor (temperature detection sensor)
13a thermistor main body
13b conductive wire
13c detection element
13d lead wire
14 leaf spring material (urging member)
14a leaf spring body
14b bent portion
14c insertion recess
14d elastic piece
14e retaining piece
15 thermistor housing portion (housing portion)
15a mounting recess
15b locking groove
15c locking surface
15d housing recess
15e opening
15f locking piece
31 stator member
31a concave and convex surfaces
51 rear side insulator member
61 front side insulator member
A width direction
B lamination direction
C gap
D insertion direction

1. A motor, comprising:
a cylindrical stator that comprises a cylindrical insulator with insulating properties in which a plurality of winding portions are arranged in a circumferential direction, and a plurality of winding coils provided on each winding portion of the insulator;
a rotor that is rotatably disposed inside the stator; and
an annular bus bar unit that supplies power to the plurality of winding coils, wherein
the bus bar unit is fixed to one end side of the insulator.

2. The motor according to claim 1, wherein
the insulator comprises a receiving portion,
the bus bar unit comprises a fixing portion fixed to the receiving portion, and
the receiving portion and the fixing portion are fixed with an adhesive.

3. The motor according to claim 2, wherein
the fixing portion is provided with a through hole, and
the receiving portion is fixed to the fixing portion by filling an adhesive with fluidity from the through hole in a state where the fixing portion is fitted.

4. The motor according to claim 2, wherein
the receiving portion is provided on an inner peripheral side of the insulator to protrude in a radially inner direction, and
the fixing portion is provided on an inner peripheral side of the bus bar unit.

5. The motor according to claim 4, wherein
the receiving portion and the fixing portion are provided to protrude in the radially inner direction to a position covering a part of the rotor.

6. The motor according to claim 4, wherein
a plurality of the receiving portions and the fixing portions are arranged in the circumferential direction.

7. The motor according to claim 6, wherein
the bus bar unit comprises a flange portion that connects the fixing portions to each other.

8. The motor according to claim 2, wherein
the receiving portion is formed in a concave shape, and
the fixing portion is formed in a protruding shape that fits into the receiving portion.

9. The motor according to claim 3, wherein
the through hole is formed in a conical shape with a diameter decreasing in a fitting direction of the receiving portion.

10. The motor according to claim 1, comprising a housing inside which the stator is fixed, wherein
the housing has an opening on a surface opposite to a side where the bus bar unit is attached, and
a lid is attached to the opening by protruding one end of the rotor.

11. A manufacturing method for manufacturing the motor according to claim 2, the manufacturing method comprising:
a winding step of winding a wire around the insulator to form the winding coil;
an assembling step of assembling the bus bar unit to the insulator;
a fixing step of fixing an end portion of the wire and a bus bar terminal of the bus bar unit; and
a bonding step of bonding the receiving portion of the insulator and the fixing portion of the bus bar unit with an adhesive.

12. The motor according to claim 3, wherein
the receiving portion is provided on an inner peripheral side of the insulator to protrude in a radially inner direction, and
the fixing portion is provided on an inner peripheral side of the bus bar unit.

13. The motor according to claim 3, wherein
the receiving portion is formed in a concave shape, and
the fixing portion is formed in a protruding shape that fits into the receiving portion.
